(19) United States
(12) Patent Application Publication
(10) Pub. No.: US 2004/0188872 A1
(43) Pub. Date: Sep. 30, 2004

(54) Method for fabricating intraocular lens with peripheral sharp edge

(76) Inventor: Dharmendra M. Jani, Fairport, NY (US)

Correspondence Address: THOMAS R. FITZGERALD, ESQ., 16 E. MAIN STREET, SUTIE 210, ROCHESTER, NY, 14614-1803, US

(21) Appl. No.: 10/403,989

(22) Filed: Mar. 31, 2003

(51) Int. Cl. B29D 11/00; B23K 26/00

(52) U.S. Cl. 264/1.32; 264/400

(57) ABSTRACT

A method of forming the sharp posterior edge of an intraocular lens (IOL) by using a laser to cut or ablate the edge of the IOL substantially cylindrically around the lens axis. The IOL is manufactured with a radius slightly larger than the final lens radius, polished, and then trimmed with the laser to produce the desired final lens shape with the sharp posterior edge. The cutting or ablation process is programmed to avoid damaging the haptic extensions of the lens. The use of a laser cutting or ablation process simplifies and accelerates the production of the lens.

### FIELD OF THE INVENTION

The present invention relates to intraocular lenses (IOLs) for implantation in an aphakic eye where the natural lens has been removed due to damage or disease (e.g., a cataractous lens). The present invention more particularly relates to IOLs designed to inhibit the unwanted growth of lens epithelial cells (LECs) between the IOL and posterior capsular bag, also known as posterior capsule opacification or “PCO” to those skilled in the art.

### BACKGROUND OF THE INVENTION

A common and desirable method of treating a cataract eye is to remove the clouded, natural lens and replace it with an artificial IOL in a surgical procedure known as cataract extraction. In the extracapsular extraction method, the natural lens is removed from the capsular bag while leaving the posterior part of the capsular bag (and preferably at least part of the anterior part of the capsular bag) in place within the eye. In this instance, the capsular bag remains anchored to the eye's ciliary body through the zonular fibers. In an alternate procedure known as intracapsular extraction, both the lens and capsular bag are removed in their entirety by severing the zonular fibers and replaced with an IOL which must be anchored within the eye absent the capsular bag. The intracapsular extraction method is considered less attractive as compared to the extracapsular extraction method since in the extracapsular method, the capsular bag remains attached to the eye's ciliary body and thus provides a natural centering and locating means for the IOL within the eye. The capsular bag also continues its function of providing a barrier between the aqueous humor at the front of the eye and the vitreous humor at the rear of the eye.

One known problem with extracapsular cataract extraction is posterior capsule opacification, or secondary cataract, where proliferation and migration of lens epithelial cells occur along the posterior capsule behind the IOL posterior surface which creates an opacification of the capsule along the optical axis. This requires subsequent surgery, such as an Er:YAG laser capsulotomy, to open the posterior capsule and thereby clear the optical axis. Undesirable complications may follow the capsulotomy. For example, since the posterior capsule provides a natural barrier between the back of the eye vitreous humor and front of the eye aqueous humor, removal of the posterior capsule allows the vitreous humor to migrate into the aqueous humor which can result in serious, sight-threatening complications. It is therefore highly desirable to prevent posterior capsule opacification in the first place and thereby obviate the need for a subsequent posterior capsulotomy.

Various methods have been proposed in the art to prevent or at least minimize PCO and thus also the number of Er:YAG laser capsultomies required as a result of PCO.

These PCO prevention methods include two main categories: mechanical means and pharmaceutical means.

In the mechanical means category of PCO prevention, efforts have been directed at creating a sharp, discontinuous bend in the posterior capsule wall which is widely recognized by those skilled in the art as an effective method for minimizing PCO. See, for example, Posterior Capsule Opacification by Nishi, Journal of Cataract & Refractive Surge, Vol. 25, January 1999. This discontinuous bend in the posterior capsule wall can be created using an IOL having a posterior edge which forms a sharp edge with the peripheral wall of the IOL.

In the pharmaceutical means of PCO prevention, it has been proposed to eliminate LEC and/or inhibit LEC mitosis by using an LEC-targeted pharmaceutical agent. See, for example, U.S. Pat. No. 5,620,013 to Bretton entitled “Method For Destroying Residual Lens Epithelial Cells”. While this approach is logical in theory, putting such a method into clinical practice is difficult due to complications arising, for example, from the toxicity of some of the LEC inhibiting agents themselves (e.g., saporin), as well as the difficulty in ensuring a total kill of all LECs in the capsular bag. Any remaining LECs may eventually multiply and migrate over the IOL, eventually resulting in PCO despite the attempt at LEC removal at the time of surgery.

By far the most promising method for inhibiting LEC formation on the posterior surface of an IOL is the mechanical means, i.e., by designing the IOL to have a sharp peripheral edge particularly at the posterior surface-peripheral edge juncture to create a discontinuous bend in the posterior capsule wall. This discontinuous bend in the posterior capsule wall has been clinically proven to inhibit the growth and migration ofLECs past this bend and along the IOL surface. One of the early reports of this PCO-inhibiting effect of a planoconvex IOL may be found in Explanation of Endocapsule Posterior Chamber Lens After Spontaneous Posterior Dislocation by Nishi et al, J Cataract & Refractive Surgery-Vol 22, March 1996 at page 273 wherein the authors examined an explanated planoconvex PMMA IOL where the posterior surface of the IOL was planar and formed a square edge with the peripheral edge of the IOL. Macroscopic view of the explanted IOL and capsule revealed a 9.5 mm capsule diameter. The open circular loops fit well along the capsule equator. The capsule equator not in contact with the haptic was also well maintained (FIG. 3). An opaque lens mass (Soemmering's ring cataract) was seen between the haptics and optic. The posterior capsule facing the IOL optic was clear.

Histopathological examination of the explanted capsule revealed few epithelial cells (LECs) on the posterior capsule. Between the loops and the optic, a lens mass with accumulation at the edge of the optic was seen (FIG. 4). There was an obvious bend in the posterior capsule at this site. II (Emphasis added.)

Thus, in the years since this report, the industry has seen much activity on creating IOLs with sharp posterior edges so as to create a sharp, discontinuous bend in the posterior capsule wall. There are several techniques currently in use for creating the sharp edges on the IOLs. Casting of the basic lens shape can produce sharp edges, but the normal polishing process for the lens has the effect of turning the sharp edge into a curved edge, negating part of the advantage of the design. Machining and milling of the edge of the lens can be done after the polishing is complete, but such processes carry the risk of producing scratches or fragments which can result in damage and irregularities in the lens. Thus there is a need for a process which will produce the requisite sharp edge on the IOL easily, quickly, and with reduced risk of damage or irregularity to the lens as a by-product of the process.

### SUMMARY OF THE INVENTION

The present invention addresses the problem of forming the sharp posterior edge of an IOL by using a laser to cut or ablate the edge of the IOL substantially cylindrically around the lens axis. The IOL is manufactured with a radius slightly larger than the final lens radius, polished, and then trimmed with the laser to produce the desired final lens shape with the sharp posterior edge. The cutting or ablation process is programmed to avoid damaging the haptic extensions of the lens. The use of a laser cutting or ablation process simplifies and accelerates the production of the lens.

### BRIEF DESCRIPTION OF THE DRAWINGS

FIG. 1 is a cross-sectional view of a human eye showing the natural lens within the capsular bag of the eye.

FIG. 2 is a cross-sectional view of a human eye showing the natural lens removed and replaced with a prior art IOL.

FIG. 3 is a plan view of a prior art IOL.

FIG. 4a is a plan view of an IOL made in accordance with the present invention.

FIG. 4b is a cross-sectional view of the inventive IOL as taken in a plane coinciding with the optic axis of the IOL.

FIG. 5 is an enlarged, fragmented, cross-sectional view showing the detail of the peripheral wall configuration of the invention's IOL.

FIGS. 6a through 6c are views of the invention's IOL showing alternate embodiments of the peripheral wall configuration of the IOL of the present invention.

FIGS. 7a through 7c are fragmented, cross-sectional views showing the angles of different embodiments of the peripheral wall configuration of the invention's IOL.

### DETAILED DESCRIPTION OF THE INVENTION

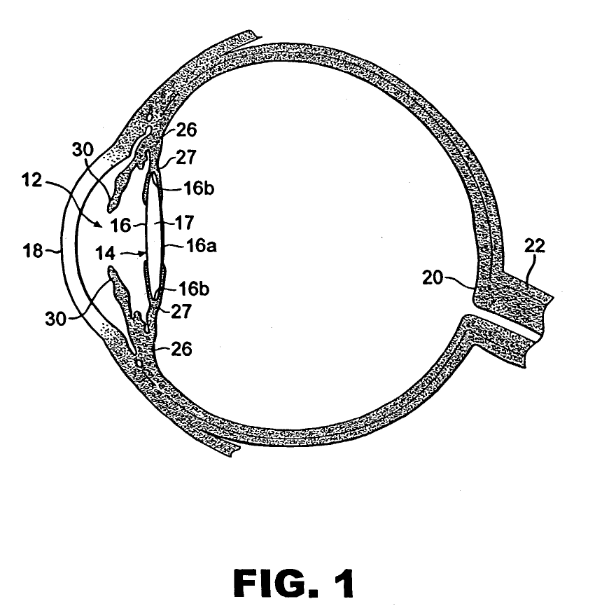

FIG. 1 shows a cross-sectional view of a human eye 10 having an anterior chamber 12 and a posterior chamber 14 separated by the iris 30. Within the posterior chamber 14 is a capsule 16 which holds the eye's natural crystalline lens 17. Light enters the eye by passing through the cornea 18 to the crystalline lens 17 which act together to direct and focus the light upon the retina 20 located at the-back of the eye. The retina connects to the optic nerve 22 which transmits the image received by the retina to the brain for interpretation of the image.

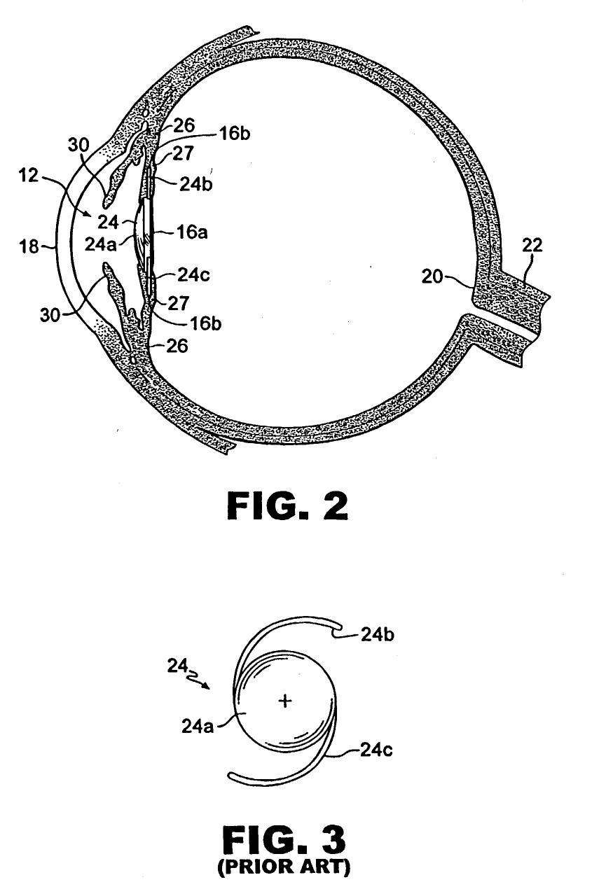

In an eye where the natural crystalline lens has been damaged (e.g., clouded by cataracts), the natural lens is no longer able to properly focus and direct incoming light to the retina and images become blurred. A well known surgical technique to remedy this situation involves removal of the damaged crystalline lens which may be replaced with an artificial lens known as an intraocular lens or IOL such as prior art IOL 24 seen in FIGS. 2 and 3. Although there are many different IOL designs as well as many different options as to exact placement of an IOL within an eye, the present invention concerns itself with fabrication and implanting of an IOL inside the substantially ovoid-shaped capsule 16 of eye 10. This implantation technique is commonly referred to in the art as the “in-the-bag” technique. In this surgical technique, a part of the anterior portion of the capsular bag is cut away (termed a “capsularhexis”) while leaving the posterior capsule 16a intact and still secured to the ciliary body 26.

Thus, in the “in-the-bag” technique of IOL surgery, the IOL is placed inside the capsule 16 which is located behind the iris 30 in the posterior chamber 14 of the eye. An IOL includes a central optic portion 24a which simulates the extracted natural lens by directing and focusing light upon the retina, and further includes a means for securing the optic in proper position within the capsular bag. A common IOL structure for securing the optic is called a haptic which is a resilient structure extending radially outwardly from the periphery of the optic. In a particularly common IOL design, two haptics 24b, 24c extend from opposite sides of the optic and curve to provide a biasing force against the inside of the capsule which secures the optic in the proper position within the capsule (see FIG. 2).

As stated earlier, an undesirable post-surgical condition known as posterior capsule opacification or PCO may occur, resulting in an implanted IOL becoming clouded and thus no longer able to properly direct and focus light. The main cause for this condition is the mitosis and migration of lens epithelial cells (LECs) across the posterior surface of the capsule behind the IOL optic.

As seen in FIG. 2, the posterior surface 16a of the capsule 16 touches the posterior surface of the IOL optic 24a. When the damaged natural lens is surgically removed, a number of LECs may remain within the capsule 16, particularly at the equator 16b thereof which is the principle source of germinal LECs. Although a surgeon may attempt to remove all LECs from the capsular bag at the time of IOL implantation surgery, it is nearly impossible to remove every single LEC. Any remaining LECs can multiply and migrate along the posterior capsule wall 16a. This is especially true in IOLs having rounded edges, where it has been found that clinically significant PCO results in about 20%-50% of patients within three years post surgery .A presently popular and effective method of preventing PCO is to create a sharp, discontinuous bend in the posterior capsule wall 16a as explained in the Background section hereof.

Heretofore, IOLs have been fabricated with a sharp edge which, when the IOL is installed in the capsular bag, presses firmly against the posterior capsule, creating the desired sharp bend in the posterior capsule wall. But as noted in the Background section, edge fabrication methods of the prior art such as lathing, molding, milling, machining, casting, or embossing tend to leave imperfections in and near the edge produced. Such imperfections arise primarily due to the mechanical interactions between the lens material and the tools being used to shape the edge, and the production of pieces of removed and partially-removed lens material which can contaminate the area of the cut.

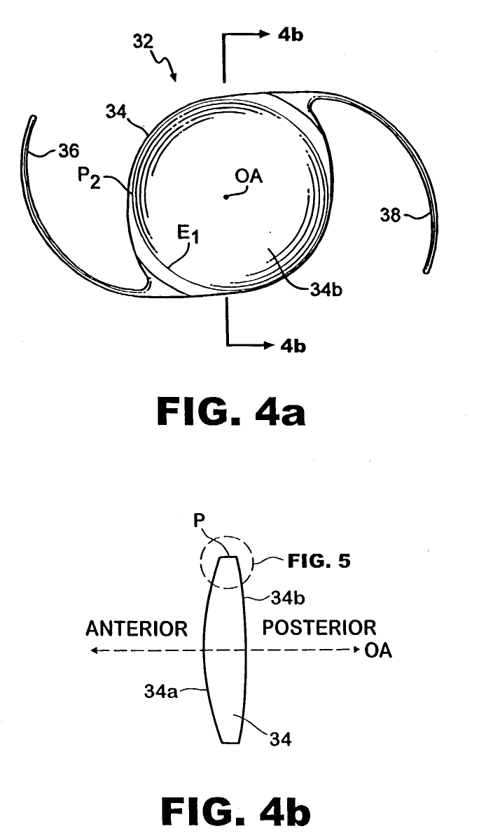

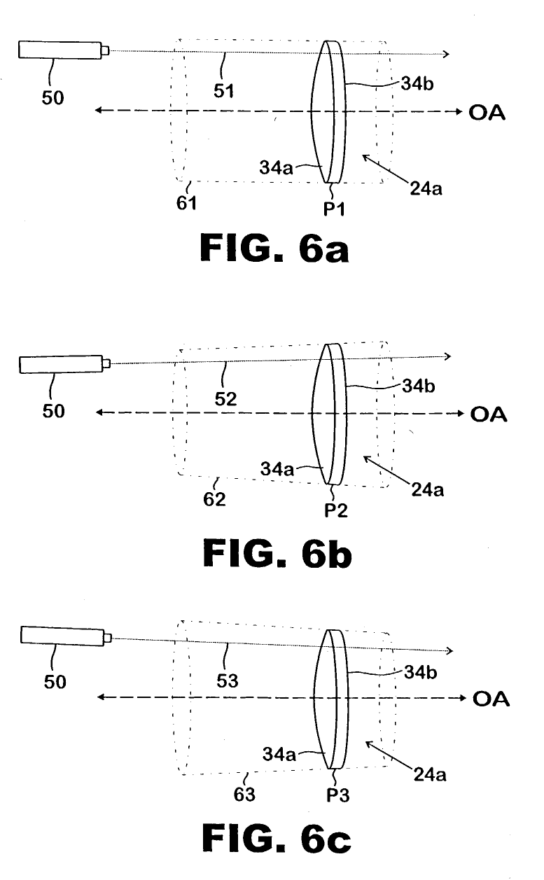

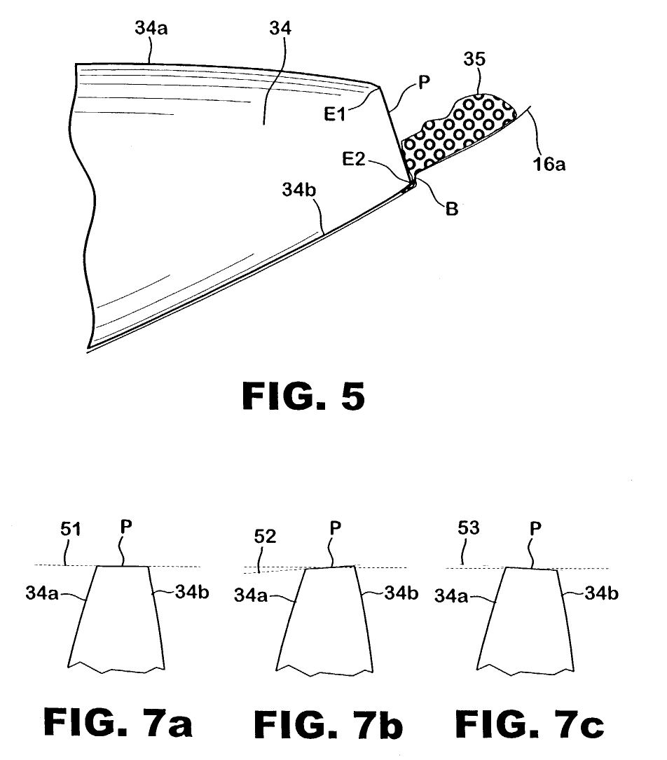

See FIGS. 4a, 4b, and 5. In contrast to the prior art, the invention uses a laser cutting or ablating process to shape the periphery P of lens 32, sharpening the anterior and posterior lens edges E1 and E2 where the lens periphery P meets the anterior and posterior optic surfaces 34a and 34b respectively. Once the lens is implanted in the capsular bag of the human eye, the sharp posterior edge E2 of the lens presses firmly against the posterior capsule, creating a sharp bend B in the posterior capsule 16a and thereby closing off access between any LECs 35 in the periphery and the capsular bag surface of posterior capsule 16a lying against the posterior lens optic surface 34b.

The inventive process comprises the following steps. First, an intraocular lens of a diameter slightly larger than required for implanting in the capsular bag of the eye is fabricated in the conventional manner, with one or more haptics extending from the optic periphery of the lens as required. Second, the lens is polished so that its optic surfaces reach the desired state of smoothness.

Third, the polished lens is mounted on a chuck in a laser cutting system. In the fourth step, the laser cutting system is used to trim the edge of the lens circularly about the lens optical axis to produce a smooth lens edge of the diameter required for implanting in the capsular bag of the eye. See FIGS. 6a, 6b, and 6c. Depending on the alignment of cutting beam 51, 52, 53 of laser 50 with respect to the optic axis OA of lens 32, the smooth lens periphery P1, P2, P3 approximates the shape of a cylinder as in FIG. 6a, or in alternate embodiments, the shape of the frustum of a cone, as in FIGS. 6b and 6c.

In the embodiment shown in FIG. 6a, cutting beam 51 of laser 50 is aligned parallel to optic axis OA of lens 32, and the path of beam 51 traces out a cylinder 61. See FIG. 7a for a magnified view of periphery P1.

In the embodiment shown in FIG. 6b, cutting beam 52 of laser 50 is aligned so that beam 52, if extended opposite its direction of travel, intersects with optic axis OA of lens 32 at a point on the anterior side 34a of lens 32. In the embodiment of FIG. 6b, the path of beam 52 traces out a conical frustum 62, resulting in a lens periphery P2 which makes a slightly more-acute angle with posterior face 34b of lens 32 than in the embodiment shown in FIG. 6a. See FIG. 7b for a magnified view of periphery P2.

In the embodiment shown in FIG. 6c, cutting beam 53 of laser 50 is aligned so that beam 53, if extended further in its direction of travel, intersects with optic axis OA of lens 32 at a point on the posterior side 34b of lens 32. In the embodiment of FIG. 6c, the path of beam 53 traces out a conical frustum 63, resulting in a lens periphery P3 which makes a slightly less-acute angle with posterior face 34b of lens 32 than in the embodiment shown in FIG. 6a. See FIG. 7c for a magnified view of periphery P3.

Additional embodiments may be realized by skewing the beam path of laser 50 with respect to optic axis OA to produce either a convex or a concave profile of lens periphery P, as desired.

The use of the laser cutting system produces a sharp edge where the lens periphery meets the posterior face of the lens. The lens is only trimmed along the portion of the lens periphery where the lens haptics do not extend, because there is no need for a lens edge underneath the haptic extensions. Consequently the laser is shut off when its beam encounters the haptic junction.

A high-powered 20W CO2 laser was used to fabricate an IOL according to the invention's process. No drying was required in order to cut the IOL material. No stress whitening or crazing was apparent. The starting diameter was provided at a larger size than the final diameter obtained by laser cutting as described here. Examination of the fabricated IOL revealed the sharp peripheral edges required for the invention.

In a final step, the trimmed lens 32 is implanted in the capsular bag of the eye with the sharp edge of the lens firmly abutting the posterior capsular surface. See FIGS. 2, 4a, 4b, and 5. When implanted within the eye, anterior optic surface 34a faces the cornea 18 and posterior optic surface 34b faces the retina 20. A pair of haptics 36, 38 are attached to and extend from opposite sides of the periphery of optic portion 34 and are configured to provide a biasing force against the interior of the posterior capsule 16a to properly position IOL 32 therein. More particularly, haptics 36, 38 are configured such that upon implanting the IOL with the capsular bag, the haptics engage the interior surface of the capsular bag. The engagement between the haptics and capsule creates a biasing force causing the IOL optic 34 to vault posteriorly toward the retina 20 whereupon the posterior surface 34b of the IOL optic presses tightly against the interior of posterior capsule wall 16a. It is noted that other known IOL positioning means are possible and within the scope of the invention. Furthermore, IOL 32 may be made from any suitable IOL material, e.g., PMMA, silicone, hydrogels and composites thereof. The IOL 32 may also be a one piece or multiple piece design (e.g. where the haptics are attached to the optic after the optic is formed.)

Referring still to FIGS. 4a, 4b and 5, it is seen that IOL optic 34 has a periphery including a posterior sharp edge E2 defined at the juncture of posterior surface 34b and peripheral wall P. With haptics 36, 38 providing the biasing force explained above, the optic posterior surface 34b presses tightly against posterior capsule wall 16.

Since posterior capsule wall 16 is somewhat resilient in nature, the force of IOL optic 34 against capsule wall 16 results in IOL 32 indenting into the posterior capsule wall. Posterior sharp edge E2 of IOL optic 34 thus forcibly indents into capsule wall 16 and thereby creates a discontinuous bend in the posterior capsule wall at this point as indicated at B in FIG. 5. As explained above, this discontinuous bend B in posterior capsule wall 16 acts to inhibit LEC migration past this point (i.e., between the posterior capsule wall 16 and IOL posterior surface 34b) and PCO is inhibited.

As mentioned above, the primary source of germinating LECs is at the equator 16b (see FIG. 2) of the capsular bag which is located radially outwardly of the optic periphery. As LECs multiply, they begin migrating radially inwardly along the capsular bag. In a patient where the optic indents into the posterior capsule as seen in FIG. 5, once the LECs reach the IOL optic 34, they will encounter sharp bend B in the capsule 16 formed by IOL sharp edge E2. This sharp bend B provides a barrier against migrating LECs. The laser cutting method of the present invention thus provides a peripheral edge configuration substantially preventing the chance of LEC migration along the posterior capsule, with reduced incidence of imperfections caused by conventional methods of fabrication and forming of the lens periphery.

What is claimed is:

1. A method of reducing the rate and intensity of posterior capsular opacification in the human eye, comprising the steps of:
a) fabricating an intraocular lens of a diameter slightly larger than required for implanting in the capsular bag of the eye, and having one or more haptics extending from the optic periphery of the lens;
b) polishing the lens to the desired state of smoothness;
c) mounting the polished lens on a chuck in a laser cutting system;
d) along the portion of the lens periphery where the lens haptics do not extend outward, trimming the edge of the lens with the laser cutting system about the lens optical axis to produce a smooth lens edge of a diameter required for implanting in the capsular bag of the eye, and having a sharp edge where the lens edge meets the posterior face of the lens;
e) implanting the trimmed lens in the capsular bag of the eye with the sharp edge of the lens firmly abutting the posterior capsular surface.

2. The method of claim 1, wherein the step of trimming the edge of the lens further comprises the step of cutting the edge of the lens with the laser cutting system.

3. The method of claim 1, wherein the step of trimming the edge of the lens further comprises the step of ablating the edge of the lens with the laser cutting system.

4. The method of claim 1 wherein the step of cutting the edge of the lens with the laser cutting system about the lens axis further comprises the step of cutting the edge of the lens with the laser cutting system cylindrically about the lens axis.

5. The method of claim 1 wherein the step of cutting the edge of the lens with the laser cutting system about the lens axis further comprises the step of cutting the edge of the lens with the laser cutting system conically about the lens axis.

6. A method of producing an intraocular lens for implanting in a human eye, comprising the steps of:
a) fabricating an intraocular lens of a diameter slightly larger than required for implanting in the capsular bag of the eye, and having one or more haptics extending from the optic periphery of the lens;
b) polishing the lens to the desired state of smoothness;
c) mounting the polished lens on a chuck in a laser cutting system;
d) along the portion of the lens periphery where the lens haptics do not extend outward, cutting the edge of the lens with the laser cutting system about the lens optical axis to produce a smooth lens edge of a diameter required for implanting in the capsular bag of the eye, and having a sharp edge where the lens edge meets the posterior face of the lens.

7. The method of claim 6, wherein the step of trimming the edge of the lens further comprises the step of cutting the edge of the lens with the laser cutting system.

8. The method of claim 6, wherein the step of trimming the edge of the lens further comprises the step of ablating the edge of the lens with the laser cutting system.

9. The method of claim 6 wherein the step of cutting the edge of the lens with the laser cutting system about the lens axis further comprises the step of cutting the edge of the lens with the laser cutting system cylindrically about the lens axis.

10. The method of claim 6 wherein the step of cutting the edge of the lens with the laser cutting system about the lens axis further comprises the step of cutting the edge of the lens with the laser cutting system conically about the lens axis.

11. A method of reducing the rate and intensity of posterior capsular opacification in the human eye, comprising the steps of:
a) selecting a lens material;
b) fabricating an intraocular lens of a diameter slightly larger than required for implanting in the capsular bag of the eye, and having one or more haptics extending from the optic periphery of the lens;
c) polishing the lens to the desired state of smoothness;
d) mounting the polished lens on a chuck in a laser cutting system;
e) along the portion of the lens periphery where the lens haptics do not extend outward, cutting the edge of the lens with the laser cutting system about the lens optical axis to produce a smooth lens edge of a diameter required for implanting in the capsular bag of the eye, and having a sharp edge where the lens edge meets the posterior face of the lens;
f) implanting the cut lens in the capsular bag of the eye with the sharp edge of the lens firmly abutting the posterior capsular surface.

12. The method of claim 11, wherein the step of trimming the edge of the lens further comprises the step of cutting the edge of the lens with the laser cutting system.

13. The method of claim 11, wherein the step of trimming the edge of the lens further comprises the step of ablating the edge of the lens with the laser cutting system.

14. The method of claim 11 wherein the step of selecting a lens material further comprises the step of selecting a lens material from the group consisting of polymethyl methacrylate (PMMA), hydrogel, silicone polymer, and acrylic polymer.

15. The method of claim 11 wherein the step of cutting the edge of the lens with the laser cutting system about the lens axis further comprises the step of cutting the edge of the lens with the laser cutting system cylindrically about the lens axis.

16. The method of claim 11 wherein the step of cutting the edge of the lens with the laser cutting system about the lens axis further comprises the step of cutting the edge of the lens with the laser cutting system conically about the lens axis.

17. A method of producing an intraocular lens for implanting in a human eye, comprising the steps of:
a) selecting a lens material;
b) fabricating an intraocular lens of a diameter slightly larger than required for implanting in the capsular bag of the eye, and having one or more haptics extending from the optic periphery of the lens;
c) polishing the lens to the desired state of smoothness;
d) mounting the polished lens on a chuck in a laser cutting system;
e) along the portion of the lens periphery where the lens haptics do not extend outward, cutting the edge of the lens with the laser cutting system about the lens optical axis to produce a smooth lens edge of a diameter required for implanting in the capsular bag of the eye, and having a sharp edge where the lens edge meets the posterior face of the lens.

18. The method of claim 17, wherein the step of trimming the edge of the lens further comprises the step of cutting the edge of the lens with the laser cutting system.

19. The method of claim 17, wherein the step of trimming the edge of the lens further comprises the step of ablating the edge of the lens with the laser cutting system.

20. The method of claim 17 wherein the step of selecting a lens material further comprises the step of selecting a lens material from the group consisting of polymethyl methacrylate (PMMA), hydrogel, silicone polymer, and acrylic polymer.

21. The method of claim 17 wherein the step of cutting the edge of the lens with the laser cutting system about the lens axis further comprises the step of cutting the edge of the lens with the laser cutting system cylindrically about the lens axis.

22. The method of claim 17 wherein the step of cutting the edge of the lens with the laser cutting system about the lens axis further comprises the step of cutting the edge of the lens with the laser cutting system conically about the lens axis.
